(19) United States
(12) Patent Application Publication
(10) Pub. No.: US 2011/0148051 A1
(43) Pub. Date: Jun. 23, 2011

(54) TOOL ATTACHMENT FOR INSTALLING KEY-LOCKING INSERTS, AND A KIT INCLUDING SUCH A TOOL ATTACHMENT

(75) Inventors: Jean-Paul Cousin, Evry (FR); Francis Dome, Arcueil (FR); Eric Engrand, Le Mee Sur Seine (FR); Thierry Rousselot, Combs La Ville (FR); Alexandre Thonnard, Paris (FR); Jean-Yves Maillet, Milly La Foret (FR)

(73) Assignee: SNECMA, PARIS (FR)

(21) Appl. No.: 12/993,632

(22) PCT Filed: May 18, 2009
(86) PCT No.: PCT/FR09/50922

§ 371 Date: Mar. 7, 2011

(30) Foreign Application Priority Data
May 19, 2008 (FR) 0853212

(51) Int. Cl. B25B 27/14; B25F 3/00

(52) U.S. Cl. 279/143

(57) ABSTRACT

A tool attachment for installing key-locking inserts, and a kit including such a tool attachment. For installing the key-locking insert, which is configured to be locked by a key, the tool attachment can be mounted on a power head, and connected to a pneumatic power supply, and includes a tightening torque transmission device, tightening the insert, and, in a casing, a key striker device configured to crimp the key onto the insert when crimping pressure is applied to the key by the pneumatic power supply. The striker device includes plural plates that are substantially perpendicular to the tightening axis. Crimping pressure applied suddenly to the plates inside the casing drives the key striker device and to crimp the keys. The tool attachment does not include moving mechanical parts, and is highly reliable.

The invention relates to the field of tool attachments for installing key-locking inserts or “key-locking bushings”.

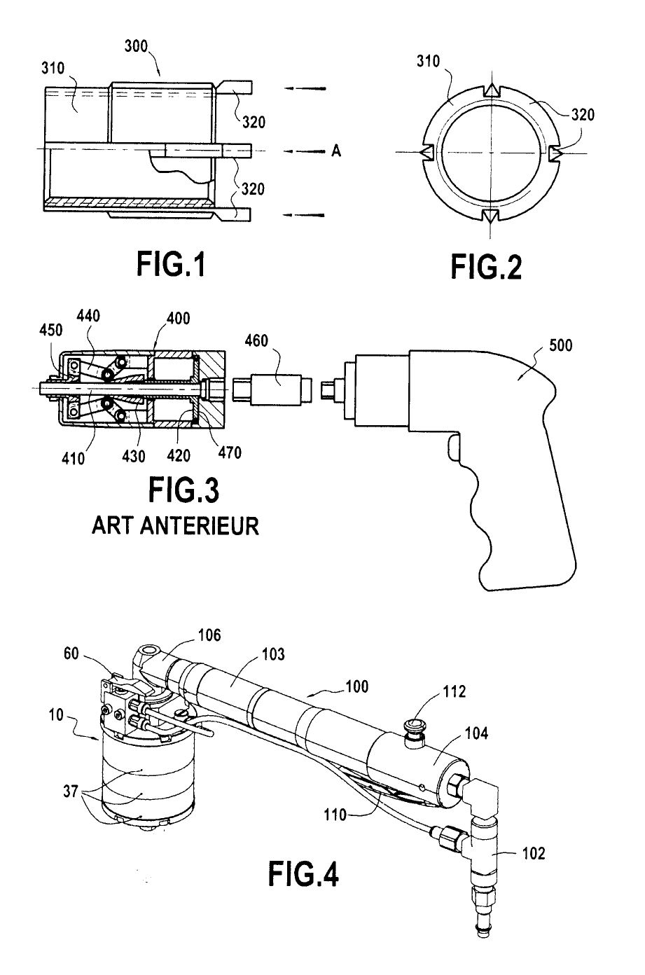

Such a key-locking insert 300 is shown in FIGS. 1 and 2. It comprises an insert body 310 or “bushing body” that is installed by being screwed in, and one or more keys 320 (four keys in the example shown) that are crimped during the installation so as to prevent any loosening or unscrewing of the insert. A key is crimped by striking it axially (along the axis of the insert body, as indicated by arrows A) so as to cause the key to penetrate by force between the insert and the hole into which said insert has been screwed.

For installing key-locking inserts, it is usual to use an installation tool attachment that is mounted on a power head. An example of such a tool attachment 400 is given in FIG. 3, where it is shown mounted on a pistol-shaped power head 500.

In order to enable the insert to be screwed in, the installation tool attachment 400 has a shaft 410, one end of which is suitable for being driven in rotation by the power head 500 via a shaft adapter 460, and the other end of which receives an insert installation tip (not shown), and, via said tip, makes it possible to screw the insert in.

In order to enable the key to be crimped, the tool attachment 400 can be connected to a pneumatic power supply. When the key is to be struck, air pressure is suddenly applied to a plate 420 (on the right surface 470 of that plate in FIG. 3). Under the effect of that pressure, said plate 420 moves, thereby driving a conical head 430. In moving, that head causes links 440 to move apart that, by toggling, propel a striker 450, in a manner such that said striker strikes the keys, thereby enabling them to be crimped.

Such key-locking inserts are used, in particular, in the aircraft industry for assembling aircraft parts, e.g. aircraft engine parts. A difficulty that often arises during such assembly is the lack of space that can complicate installing the insert, or, in some situations, even prevent the insert from being installed.

Thus, in order to make the tool attachment compact, the diameter of the tool attachment cannot exceed a certain size. Therefore, the surface area of the plate is limited, and the pressure force applied thereto is also limited. That is why, in order to transmit to the striker a force that is sufficient to make it possible to crimp the key, the above-mentioned system of links 440 is used to gear down the movement of the plate 420. By means of this system, for a given stroke (movement) of the plate 420, the striker 450 travels over a stroke that is only a fraction of said given stroke. Thus, the force available for striking is increased, and the key can be crimped under appropriate conditions.

However, that system suffers from the drawback that the links 440, which are subjected to considerable mechanical stress, wear rapidly. That tool attachment for installing key-locking inserts is thus unreliable, and the links often need to be replaced or repaired.

A first object of the invention is to provide a tool attachment for installing a key-locking insert that is designed to be locked by a key, which tool attachment is suitable for being mounted on a power head, and is suitable for being connected to a pneumatic power supply, said tool attachment including a tightening torque transmission device, making it possible to tighten the insert along a tightening axis when tightening torque is applied to said device by the power head, and a key striker device housed in a casing, making it possible to crimp the key onto the insert when crimping pressure is applied to said key by the pneumatic power supply, which tool attachment is highly reliable and is compact.

This object is achieved by means of that fact that the striker device has a plurality of plates that are substantially perpendicular to the tightening axis, that are at least partially superposed therealong, and that are suitable, under the effect of the crimping pressure applied suddenly to them, for driving the striker device and for enabling the key to be crimped.

Although the above definition of a tool attachment of the invention is given with reference to a single key, it can naturally be understood that such a tool attachment is designed to install an insert either having a single key or a plurality of keys. If it has a plurality of keys, the key striker device makes it possible to strike all of the keys in a single operation.

By using a plurality of plates (e.g. two, three, or four plates), instead of the crimping pressure being applied to a single surface, of area that cannot exceed the cross-sectional area of the tool attachment, said crimping pressure is applied to a set of surfaces (the surfaces of the plates). In this way, it is possible to double, triple, or increase to an even greater extent the surface area subjected to the crimping pressure, and thus to apply to the striker device a force sufficient for it to crimp the key(s) effectively.

Advantageously, since the plates are at least partially superposed along the tightening axis, the radial compactness of the tool attachment is greater than if only a single plate were provided. By means of this, the tool attachment remains relatively compact. In practice, plates of the same size are generally provided, disposed in succession along the tightening/striking axis, and extending perpendicularly thereto. The outside periphery of the casing is substantially the same as the outside periphery of the plates.

In an embodiment, the striker device is made up of parts that are stationary relative to one another. The use of a plurality of plates makes it possible to use mechanical gearing systems, such as a linkage. Thus, the striker device can advantageously be made up of stationary parts, with no moving portions, thereby enabling it to offer excellent reliability.

However, the use of a plurality of plates for increasing the pressure force applied to the striker device does not exclude using a mechanical device (in particular for gearing), of the linkage type or of some other type, depending on the specific constraints for installing the key-locking insert.

In an embodiment, for performing the tightening, the torque transmission device has a tightening shaft having one end suitable for being driven in rotation by the power head, and its other end suitable for being connected to a tightening adapter.

In an embodiment, the striker device has a sleeve-shaped portion mounted to slide coaxially about a shaft transmitting the tightening torque, the plates being disposed in the casing around said sleeve-shaped portion, at least one of the plates being removable relative to said sleeve-shaped portion. In this situation, the shaft is naturally part of the tightening torque transmission device. It then also serves to guide the striker device. The design of the striker device with at least one plate that can be removed from the sleeve-shaped portion makes it possible to replace, when necessary, the removable plate(s) only, without having to replace the entire striker device.

In addition, in an embodiment, the plates and/or casing elements have no undercuts in the tightening direction, thereby facilitating manufacture thereof, in particular machining thereof. The casing can thus be made up of a stack of casing pieces that do not have any undercuts. It is then possible to make provision to assemble together its successive elements by screws disposed in the tightening direction. Advantageously, the screws can simultaneously secure together a plurality of casing portions, e.g. four casing portions in the embodiment shown in the figures.

In an embodiment, the tool attachment further includes return means for urging back the striker device, which means make it possible, after a strike, to cause the striker device to return to an initial position making it possible for another strike to take place.

In an embodiment, the return means for urging back the striker device comprise at least one spring, e.g. a set of compression springs spaced apart uniformly around the circumference of the casing.

In another embodiment, at least one air duct provided in one or more walls of the casing makes it possible for the plates to be put under air pressure.

The air duct is thus formed without adding any additional parts, and it is protected against impacts during use of the tool attachment, by the body itself of the casing.

A second object of the invention is to provide a tightening and key-installation kit comprising a power head and a key installation tool attachment that is highly reliable and that is quite compact.

This object is achieved by means of the fact that the tightening and key-installation kit includes a key-installation tool attachment as described above.

In such a kit, the power head is adapted to receive the tool attachment for installing key-locking inserts.

It can be provided with a trigger for triggering a sudden increase in pressure in the tool attachment for installing key-locking inserts, thereby making it possible to crimp the key.

The invention can be well understood and its advantages appear more clearly from the following description of embodiments given by way of non-limiting example. The description refers to the accompanying drawings, in which:

FIGS. 1 and 2, described above, are respectively a diagrammatic side view and a diagrammatic end view of a key-locking insert;

FIG. 3, described above, is an axial section view of a known power head and of a known tool attachment, making it possible to install key-locking inserts;

FIG. 4 is a diagrammatic perspective view of a power head and of a tool attachment of the invention for installing inserts;

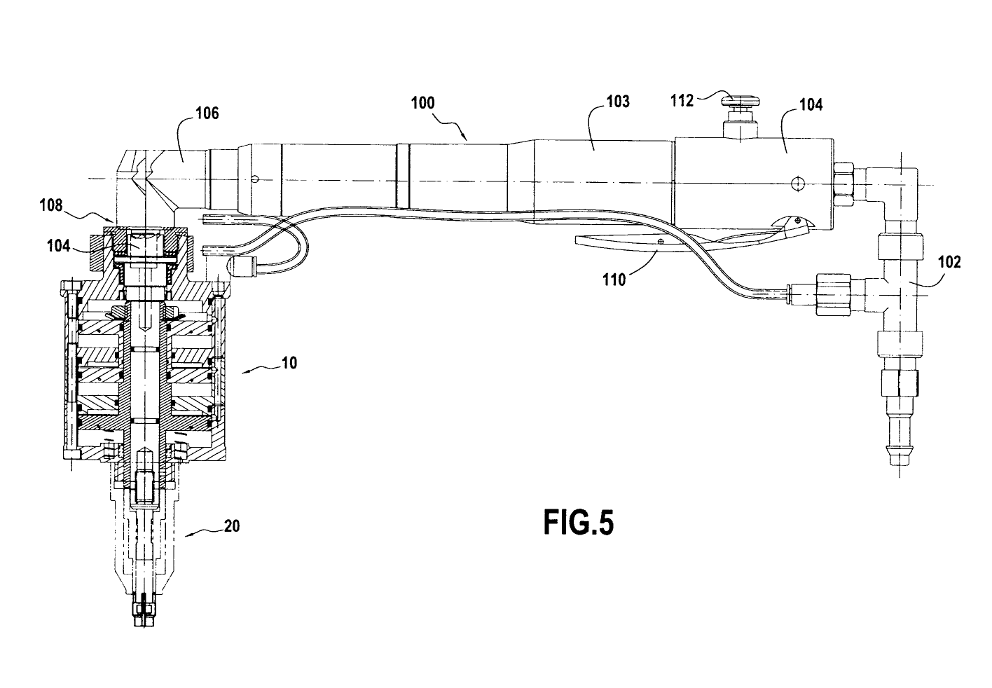

FIG. 5 is a diagrammatic side view of the power head and of the tool attachment of FIG. 4, the tool attachment being shown in axial section in the initial, pre-strike position; and

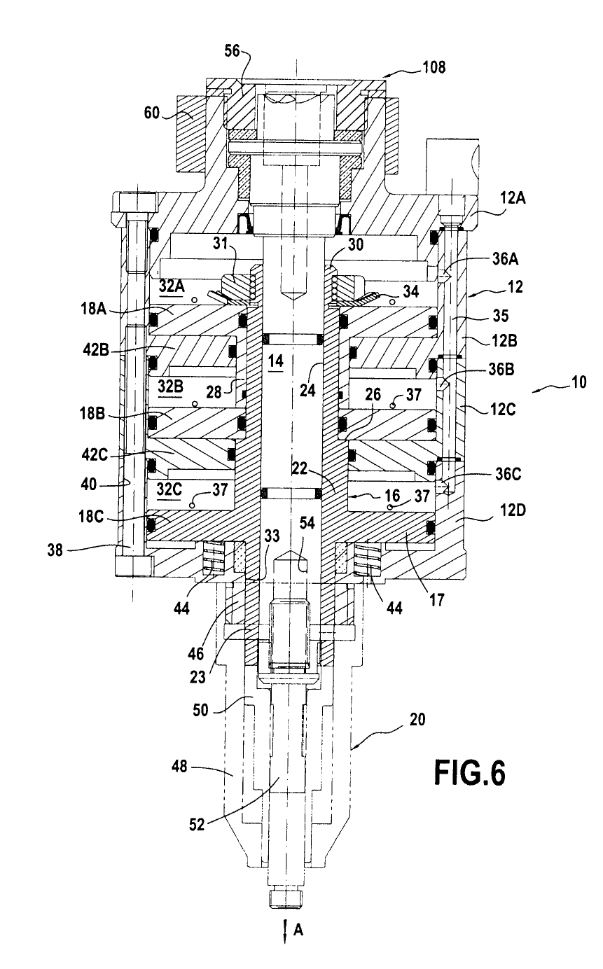

FIG. 6 is an enlargement of the axial section view of the insert installation tool attachment of FIGS. 4 and 5, shown in the final, post-strike position.

A power head 100 equipped with a tool attachment 10 of the invention for installing key-locking inserts is described below with reference to FIGS. 4 to 6.

The power head 100 is an angled driver making it possible to tighten all types of bolts or the like. The power head 100 is powered by a pneumatic power supply (not shown) via a coupling 102. It has an elongate body 103 containing means for using the pressure of the power air in such a manner as to deliver output tightening (or loosening) torque. The air feed coupling 102 is connected to a first end 104 of the power head 100. At the other end 106 of said power head, which end forms a right angle, the power head 100 has a coupling interface 108 making it possible to fasten and to drive a tightening connector or some other tool attachment suitable for being mounted on the power head 100.

Finally, the power head 100 has trigger means (lever 110) making it possible to put the power head 100 under air pressure and to cause the tightening to take place. A reverse button 112 is also provided on the power head 100 to cause it to go into loosening mode and to reverse the rotation direction if so desired.

The tool attachment 10 for installing a key-locking insert is fastened to the coupling interface 108 of the power head 100.

Said tool attachment 10 is constituted mainly by a casing 12 in four portions 12A, 12B, 12C, and 12D, by a shaft 14, and by a striker device 16. The striker device 16 comprises a striker 17, two inner plates 18A and 18B, and an insert installation tip 20 fastened to the downstream end of the striker 17 relative to the tightening/striking direction.

Inside the casing 12, the striker device 16 (and more precisely the striker 17) has a sleeve-shaped main portion 22 and a plate 18C. The sleeve-shaped portion 22 has an internal passage 24 of diameter substantially equal to the diameter of the shaft 14, ignoring clearance. The striker device 16 is mounted in such a manner as to be slidable on the shaft 14 disposed in the passage 24 in the striker 17.

The plate 18B that is of circular shape is disposed around the sleeve-shaped portion 22 of the striker 17. A shoulder 26 is provided on said sleeve-shaped portion for the purpose of locking the plate 18B on the sleeve-shaped portion 22 and of preventing it from moving in the tightening/striking direction A.

The plate 18A that is also of circular shape is disposed around the sleeve-shaped portion 22 on the same side of the plate 18B as the coupling interface 108. Said plate 18A is extended in the tightening direction by a cylindrical portion 28 that clamps around the sleeve-shaped portion 22 and that has its downstream end relative to the tightening direction A resting on the plate 18B, thereby preventing said plate 18B from rising towards the coupling interface 108.

Finally, that end 30 of the striker device 16 that faces towards the coupling interface 108 is externally threaded, and a nut 31 associated with a washer 34 is tightened around said end 30 in such a manner as to lock the stack of plates 18A, 18B and as to prevent them from rising towards the coupling interface 108.

By means of this nut 31, the various parts of the striker device 16, namely, in particular, the striker 17, the two plates 18A and 18B, and the insert installation tip 20, are secured rigidly together.

It should be noted that any system making it possible to secure the plates 18A and 18B (and even 18C) to the sleeve portion 22 of the striker device 16 may also be used in other embodiments of the invention.

The casing 12 is made up of four portions 12A-12D that are fastened together by a set of screws 38 passing through passages 40 formed in the volume of the casing 12 in the tightening/striking direction A. The casing is cylindrical in general shape, the end pieces 12A and 12D forming lids at the ends of the casing.

The casing portions 12B and 12C also have respective stationary separator plates 42B and 42C that are extended to the sleeve-shaped portion 22 and that thus contribute to guiding and to holding the striker device 16. Inside the casing, the end piece 12A, the separator plates 42B and 42C, and the end piece 12D define and separate three independent and substantially closed chambers 32A, 32B, and 32C, each of which is in the shape of a cylinder segment.

Each of the plates 18A, 18B, and 18C extends in a respective one of the chambers 32A, 32B, and 32C perpendicular to tightening/striking direction, and can move over a limited stroke between an initial, pre-strike position, in which the plate is at the upstream end relative to the tightening/striking direction, to a final, post-strike position, in which it is in abutment against that wall of the chamber that is at its downstream end relative to the tightening/striking direction (these walls are the separator plates 42B, 42C and the casing end piece 12D).

The chambers 32A, 32B, and 32C are connected to a pressurized air feed duct 35 via feed orifices 36A, 36B, 36C. These orifices open out on the upstream sides of the plates 18A, 18B, and 18C, relative to the tightening/striking direction A. In this way, the air pressure in the chambers 32A-32C, coming from the duct 35, tends to push the plates 18A, 18B, and 18C in the tightening direction. The air feed duct 35 is formed in the volume itself of the wall of the casing 12.

After the keys have been struck, and in order to enable the air pressure to decrease again in the chambers 32A, 32B, and 32C, each of said chambers has at least one opening (three openings 37 in this example, disposed at 120° intervals, as seen looking along the tightening axis). The openings of the chambers 32A-32C are provided through the wall of the casing 12, and are designed to put the chambers 32A-32C into communication with the outside of the casing, when the plates 18A, 18B, and 18C are substantially in their downstream end positions relative to the tightening/striking direction, after striking. So long as the plates 18A, 18B, and 18C are substantially not in these positions, the openings 37 are obstructed by the plates, thereby preventing air from escaping via said openings and preventing the pressure from decreasing inside the chambers 32A-32C.

Finally, the striker device 16 is subjected to the action of a set of helical springs 44 that are placed in counterbores arranged in the tightening direction A in the bottom of the casing 12 (portion 12D). These springs urge the striker device 16 back in the direction opposite from the tightening/striking direction by pushing back the plate 18C of the striker device 16.

In the tightening direction A, the striker 17 is terminated by a cylindrical portion 23 extending outside the casing 12.

Said cylindrical portion 23 at the end of the striker device 16 is guided outwardly in the striking movement by the internal passage 33 formed in the end of the casing portion 12D that is a sleeve-shaped portion 46. The insert installation tip 20 is fastened onto the threaded outside of the sleeve-shaped portion 46. In known manner, said installation tip 20 comprises a stationary cylindrical body 48, in which a hammer 50 secured to the striker 17 is slidably mounted. In addition, a tightening adapter 52 screwed into a counterbore 54 in the shaft 14 makes it possible to transmit the tightening torque from the shaft 14 to the insert, during the step for tightening said insert.

The tool attachment 10 is fastened to the power head 100 in the following manner: a ring 56 is screwed into a thread of a counterbore provided in the coupling interface 108 of the body 103 of the power head 100. The casing portion 12A is screwed onto the ring 56. In order to drive the shaft 14 in rotation, a drive square of the power head provides the coupling relative to the shaft 14, making it possible to transmit the rotary movement (tightening/loosening) of said shaft.

In addition, a trigger 60 (FIG. 4) making it possible to put the feed duct 35 under air pressure and thus to trigger the striking is fastened to the casing portion 12A.

The tool attachment 10 for installing key-locking inserts operates as follows:

The insert is brought to the location provided for it.

The insert is tightened conventionally by means of the tightening adapter, as driven in rotation by the power head 100 via the shaft 14.

The keys are then crimped in the following manner: by pressing on the trigger 60, access to the feed duct 35 is opened for feeding in pressurized air delivered by the pneumatic power supply.

The portions of the chambers 32A, 32B, and 32C that are situated upstream relative to the screwing/striking direction are put under pressure (typically under a pressure of about 6 bars) almost instantly. Subjected to this pressure, the three plates 18A, 18B, and 18C are pushed sharply in the tightening/striking direction. The plate 18A drives the plate 18B via its cylindrical portion 28, and said plate 18B drives the sleeve-shaped portion 22 of the striker 17 (by means of the shoulder 26). Thus, the striker device moves suddenly in the tightening/striking direction, and the hammer 50 crimps the keys around the insert.

When the plates 18A, 18B, and 18C reach their downstream end positions relative to the tightening/striking direction, the openings 37 are no longer obstructed. The pressurized air escapes via these openings 37, thereby causing the pressure inside the chambers 32A, 32B, and 32C to return to ambient pressure, and making it possible for the plates 18A, 18B, and 18C to move back up.

1-8. (canceled)

9. A tool attachment for installing a key-locking insert configured to be locked by a key, which tool attachment is configured to be mounted on a power head, and to be connected to a pneumatic power supply, the tool attachment comprising:
a tightening torque transmission device configured to tighten the insert along a tightening axis when tightening torque is applied to the device by the power head; and
a key striker device housed in a casing, configured to crimp the key onto the insert when crimping pressure is applied to the key by the pneumatic power supply,
wherein the striker device includes a plurality of plates that are substantially perpendicular to the tightening axis, that are at least partially superposed therealong, and that are configured, under effect of the crimping pressure applied suddenly to them, to drive the striker device and to enable the key to be crimped.

10. A tool attachment for installing a key-locking insert according to claim 9, in which the striker device includes parts that are stationary relative to one another.

11. A tool attachment for installing a key-locking insert according to claim 9, in which the striker device includes a sleeve-shaped portion mounted to slide coaxially about a shaft transmitting the tightening torque, the plates being disposed in the casing around the sleeve-shaped portion, at least one of the plates being removable relative to the sleeve-shaped portion.

12. A tool attachment for installing a key-locking insert according to claim 9, further comprising return means for urging back the striker device, which means make it possible, after a strike, to cause the striker device to return to an initial position making it possible for another strike to take place.

13. A tool attachment for installing a key-locking insert according to claim 12, in which the return means for urging back the striker device comprises at least one spring.

14. A tool attachment for installing a key-locking insert according to claim 9, further comprising at least one air duct provided in one or more walls of the casing configured to put the plates under air pressure during the strike.

15. A tool attachment for installing a key-locking device according to claim 9, in which the striker device has exactly three plates.

16. A tightening and key-installation kit, comprising a power head and a tool attachment according to claim 9.

17. A tightening and key-installation kit, comprising a power head and a tool attachment according to claim 10.

18. A tightening and key-installation kit, comprising a power head and a tool attachment according to claim 11.

19. A tightening and key-installation kit, comprising a power head and a tool attachment according to claim 12.

20. A tightening and key-installation kit, comprising a power head and a tool attachment according to claim 13.

21. A tightening and key-installation kit, comprising a power head and a tool attachment according to claim 14.

22. A tightening and key-installation kit, comprising a power head and a tool attachment according to claim 15.
